(19) United States
(12) Patent Application Publication
(10) Pub. No.: US 2005/0182858 A1
(43) Pub. Date: Aug. 18, 2005

(54) Portable memory device with multiple I/O interfaces

(75) Inventors: Hai-Cha Lo, Taipei (TW); Yao-Wen Hsu, TaiNan (TW); Chun-Cheng Lu, Touliu City (TW); Meng-Hau Chen, Taoyuan (TW); Wei-Lun Hsu, Taipei (TW)

Correspondence Address: BRUCE H. TROXELL, SUITE 1404, 5205 LEESBURG PIKE, FALLS CHURCH, VA, 22041, US

(73) Assignee: InCOMM Technologies Co., Ltd.

(21) Appl. No.: 11/052,790

(22) Filed: Feb. 9, 2005

(30) Foreign Application Priority Data
Feb. 13, 2004 (TW) 93103421

(51) Int. Cl. G06F 3/00

(52) U.S. Cl. 710/1

(57) ABSTRACT

A portable memory device with multiple I/O interfaces, comprising: a storage device, a control unit capable of controlling the storage device to access the data, and at least two different I/O interface units. The two or more I/O interface units are capable of transferring data stored in the storage device with different I/O interface standards corresponding to the two or more external devices to achieve the object of connecting a single portable memory device with either one or both of the external devices possessing different interfaces.

### FIELD OF THE INVENTION

The present invention relates to a portable memory device with multiple I/O interfaces, and more particularly, to a portable memory device with multiple I/O interfaces capable of directly connecting with many peripherals of different interfaces, such as a flash memory device equipped with both the Secure Digital (SD) and Universal Serial Bus (USB) interfaces.

### BACKGROUND OF THE INVENTION

With the advances in the information technologies, demands on varieties of information are fast growing. In the recent years, popularization of many compact portable memory devices fulfills the thirst of information portability, which includes the USB flash disk using flash memory as the storage medium, various types and standards of flash memory cards such as compact flash (CF), memory stick (MS), secure digital (SD), MMC, xD, and etc., micro hard disk with CF or USB interface, or even the 2.5″ hard disk in an external module with USB or PCMCIA interface.

The conventional portable memory devices nowadays must include a non-volatile memory array, a controller, and an I/O interface. The memory array is used to store the data that user wants to store. To have the feature of preserving the stored data without providing external power, a flash memory is commonly used as the storage array, while a hard disk can also be used as well. The controller includes the drive and the relative circuits, interface, and driven mechanism for the memory array. The driven mechanisms can be a hardware command sequencer circuit executing a series of micro-code programs, or a hardware micro-controller/micro-processor circuit executing a series of firmware programs in the controller of the portable memory device. Meanwhile, the I/O interface of the portable memory device determines the protocol to be used by the same to connect and communicate with external devices. For instances, a personal digital assistant (PDA), digital camera, or digital video (DV) uses CF, SD, or MS interface, while a personal computer, notebook, and tablet PC usually use the USB interface as the standard I/O interface but not the CF, SD, or MS interface.

Accordingly, each manufacturer of the different digital camera and digital video currently supports and promotes different types of memory cards, which are not mutually compatible. Moreover, those memory cards used nowadays for the digital camera, digital video, or PDA, can not be used in a PC or notebook directly but require a card reader to adapt the interface of the memory card into the USB standard and then connect to the USB interface of the computer. On the contrary, the common portable memory device for the computers with the USB interface, such as the USB flash disk or the micro hard disk with the USB interface, can not be used in those peripherals that have only a CF, SD, or MS interface. As the consequence, consumers have to purchase many memory cards with different interfaces for the peripherals that have different interface standards. Moreover, card readers are also needed to connect the purchased memory cards to the computer. This inconvenience in the usage wastes not only financially but also in the social resources, which is definitely waiting for improvements.

### SUMMARY OF THE INVENTION

The primary object of the present invention is to provide a portable memory device with multiple I/O interfaces, by installing two types of interface, capable of directly connecting with many peripherals with different I/O interfaces that not only can conserve the financial and social resources, but also is user friendly.

To achieve the above-mentioned object, the present invention provides a portable memory device with multiple I/O interfaces comprising a storage device, a control unit, a first I/O interface unit, and a second I/O interface unit. The control unit is connected with the storage device and capable of controlling the storage device to access the data. The first I/O interface unit is connected with the control unit, capable of connecting with a first external device with the identical first I/O interface and accessing the data stored in the storage device through the first I/O interface unit with the standard of the first I/O interface unit. The second I/O interface unit is connected with the control unit, capable of connecting with a second external device with the identical second I/O interface and accessing the data stored in the storage device through the second I/O interface unit with the standard of the second I/O interface unit. Accordingly, the object of connecting a portable memory device with one or two of the two external devices with different I/O interfaces at the same time directly can be achieved.

In another preferred embodiment of the present invention, the control unit further comprises a switch circuit with pins connected with the first and the second I/O interface units, capable of alternating the control unit to access the data through either the first or the second I/O interface unit by applying a voltage on either the first or the second I/O interface unit, that the alternating is controlled by the switch circuit.

### BRIEF DESCRIPTION OF THE DRAWINGS

FIG. 1 is a schematic drawing of a portable memory device with multiple I/O interfaces according to a first preferred embodiment of the present invention.

FIG. 2 is a schematic drawing of a portable memory device with multiple I/O interfaces functioning with two peripherals according to the present invention.

FIG. 3 is a schematic drawing of a portable memory device with multiple I/O interfaces 10 plugged in the memory card slot 41 of a PDA 40 according to the present invention.

FIG. 4 is a schematic drawing of a portable memory device with multiple I/O interfaces 10 plugged in the I/O interface slot 51 of a computer 50 according to the present invention.

FIG. 5A and FIG. 5B are a front-view and side-view of a portable memory device with multiple I/O interfaces 10 of FIG. 1.

FIG. 6A and FIG. 6B are a front-view and side-view of a portable memory device 10a with multiple I/O interfaces according to another preferred embodiment of the present invention.

FIG. 7 is a functional flow chart of the present invention.

FIG. 8 is a schematic drawing of a portable memory device with multiple I/O interfaces 10b according to a second preferred embodiment of the present invention.

FIG. 9 is a schematic drawing of a portable memory device with multiple I/O interfaces 10c according to a third preferred embodiment of the present invention.

FIG. 10 is a schematic drawing of a portable memory device with multiple I/O interfaces of FIG. 9 functioning with both a digital camera and a notebook.

FIG. 11 is a flow chart depicting a portable memory device with multiple I/O interfaces functioning with both a digital camera and a notebook according to FIG. 10, which is the combination of FIG. 11A and FIG. 11B.

FIG. 12 is a schematic drawing of an SD flash memory card.

FIG. 13 is another flow chart depicting a portable memory device with multiple I/O interfaces functioning with both a digital camera and a notebook according to FIG. 10, which is the combination of FIG. 13A, FIG. 13B, FIG. 13C and FIG. 13D.

### DESCRIPTION OF THE PREFERRED EMBODIMENT

The primarily principle of the portable memory device with multiple I/O interfaces of the present invention is to install including a storage device, a control unit, a first I/O interface unit, and a second I/O interface unit on the portable memory device. The control unit is connected with the storage device and capable of controlling the storage device to access the data. The first I/O interface unit is connected with the control unit, capable of connecting with a first external device with the identical first I/O interface and accessing the data stored in the storage device through the first I/O interface unit with the standard of the first I/O interface unit. The second I/O interface unit is connected with the control unit, capable of connecting with a second external device with the identical second I/O interface and accessing the data stored in the storage device through the second I/O interface unit with the standard of the second I/O interface unit. Accordingly, the object of connecting a portable memory device with one or two of the two external devices with different I/O interfaces at the same time directly can be achieved.

To make the esteemed review committee can further understand and recognize the present invention, a detailed description in accordance with several accompanying diagrams are presented as following:

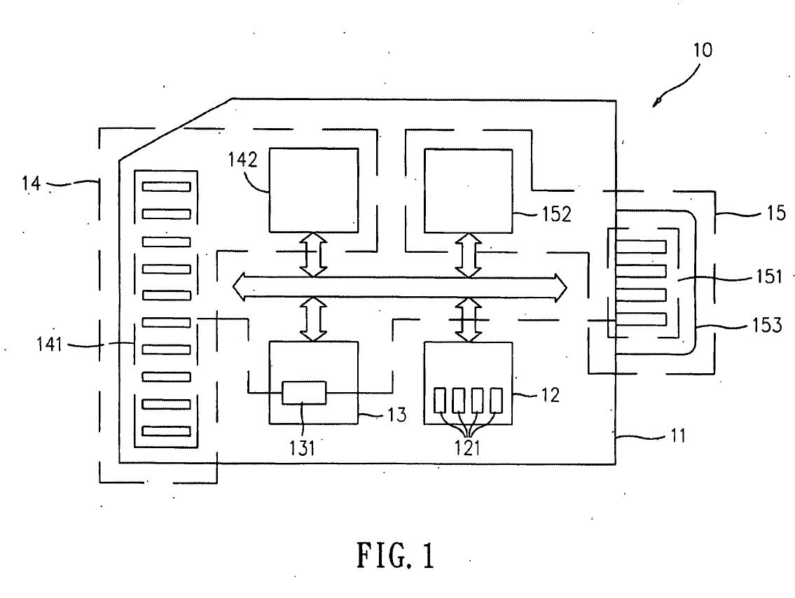

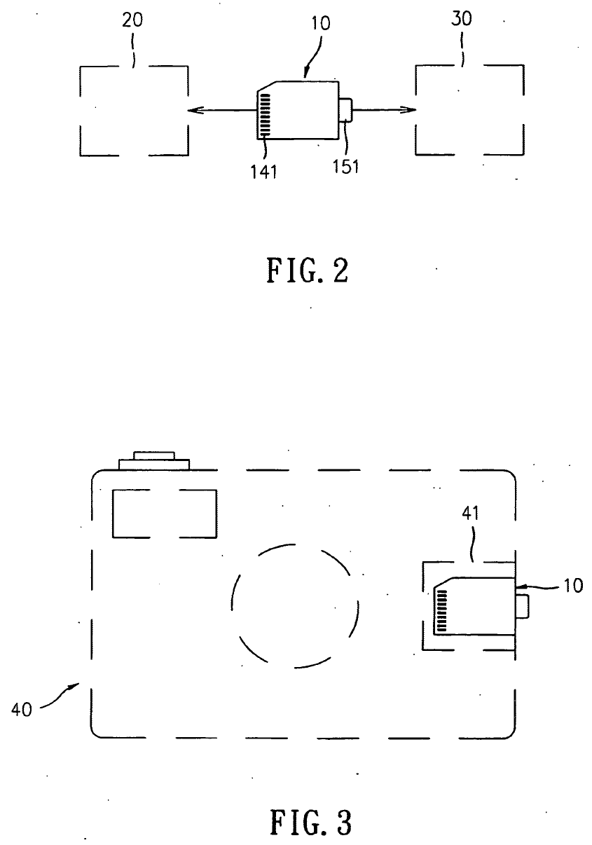

Please refer to FIG. 1 and FIG. 2, which are the schematic drawings of a portable memory device with multiple I/O interfaces 10 according to a first preferred embodiment of the present invention. An SD flash memory is used in FIG. 1 for the portable memory device 10 in the first preferred embodiment of the present invention. Nevertheless, it can be other types of memory media, such as an USB flash disk, a MS memory card, a MMC memory card, a CF memory card, an xD memory card, a micro hard disk with CF or USB interface, or other portable memory devices 10.

Please refer to FIG. 1 and FIG. 2, a portable memory device in the first preferred embodiment of the present invention comprises: a body 11, a storage device 12, a control unit 13, a first terminal set 141, a second terminal set 151, a first I/O interface controller 142, and a second I/O interface controller 152.

The body 11 forms the outline of the portable memory device 10 and provides the spaces and supports for other installed elements. The storage device 12 is installed on the body 11. In this preferred embodiment, the storage device 12 comprises the memory array formed by several non-volatile memory chips 121 such as the flash memory array, capable of storing and preserving the data without external power. Nevertheless, the storage device 12 of the preferred embodiment of the present invention is not limited to the flash memory array, it can be a latch circuit, a random access memory (RAM), a read only memory (ROM), an erasable programmable ROM (EPROM), an electrical erasable programmable ROM (EEPROM), a hard disk, and etc. The controller 13 is installed on the body and connected with the storage device 12, capable of driving and controlling the storage device 12 to access the data in the external devices 20, 30 (as shown in FIG. 2).

The first terminal set 141 and the first I/O interface controller 142 together form a first I/O interface unit 14. The first I/O interface unit 14 is connected with the control unit 13 capable of transferring the data stored in the storage device 12 through the first I/O interface unit 14 with the standard of the first I/O interface. In the present preferred embodiment, the first I/O interface is an SD memory card interface. Therefore, the outline and the structure of the body 11 are designed to accommodate the SD memory card in specification, size, and shape forming a thin card structure. The first terminal set 141 is the terminal set that matches with the specification of the SD memory card (as shown in FIG. 1), arranged at one end and exposed to the body 11 capable of connecting electronically with a first external device 20 possessing the identical interface (as shown in FIG. 2). The first terminal set 141 is distributed according to the specification of the first I/O interface (i.e. SD memory card interface). In the present preferred embodiment, the first I/O interface controller 142 matches with the interface controller (or the drive circuit) of the SD memory card. The first I/O interface controller 142 is connected with both the first terminal set 141 and the control unit 13, capable of converting the data signal from the first terminal set 141 with the standard of the first I/O interface to the data that can be processed and stored by the control unit 13 and storage device 12 respectively, and contrarily, converting the data from the storage device 12 to the data signal with the standard of the first I/O interface and then sending out by the first terminal set 141.

Similarly, the second terminal set 151 and the second I/O interface controller 152 together form a second I/O interface unit 15. The second I/O interface unit 15 is also connected with the control unit 13 capable of transferring the data stored in the storage device 12 through the second I/O interface unit 15 with the standard of the second I/O interface. In the present preferred embodiment, the second I/O interface is an USB I/O interface. Therefore, an USB plug 153 is arranged at the other end and exposed to the body 11 that is opposite to the previously described SD memory card interface and the first terminal set 141. The second terminal set 151 is the terminal set that matches with the specification of the USB interface arranged in the USB plug 153, capable of connecting electronically with a second external device 30 possessing the identical interface (as shown in FIG. 2). In the present preferred embodiment, the second I/O interface controller 152 matches with the USB I/O interface controller (or the drive circuit). The second I/O interface controller 152 is connected with both the second terminal set 151 and the control unit 13, capable of converting the data signal from the second terminal set 151 (i.e. USB plug 153) with the standard of the second I/O interface to the data that can be processed and stored by the control unit 13 and storage device 12 respectively, and contrarily, converting the data from the storage device 12 to the data signal with the standard of the second I/O interface and then sending out by the second terminal set 151.

It is noted that the SD memory card and the USB I/O interfaces described previously are only one of the possible embodiments of the first and the second I/O interfaces. For instances, the first and the second I/O interfaces can be a PCMCIA, an USB, an SD, a MS, a MMC, a CF, an xD, a wire LAN, a wireless LAN, or any other conventional I/O interfaces for digital data signals. Certainly, in any case the outline and the size of the body 11 has to match with either the first or the second I/O interface. As in the present preferred embodiment, typically however, it is better to have different standards for the first and the second O/I interfaces that are incompatible with each other. With that the multiple I/O interfaces portable memory device 10 of the present invention can achieve the object of connecting with peripherals with different I/O interfaces directly to save money and social resources while making it more convenient to use.

In addition, although the control unit 13, the first I/O interface controller 142, and the second I/O interface controller 152 of the present preferred embodiment shown in FIG. 1 are represented by three independent element blocks, the three controllers (or elements) 13, 142, 152 of the present invention are not limited to be three independent controller chips. On the contrary, these three controllers (or elements) 13, 142, 152 can be integrated onto a single IC (i.e. single controller chip) as shown in the other preferred embodiment of the present invention.

Moreover, the number of the I/O interface unit in the present invention is not limited to two. Three of more I/O interface units can be arranged on the same portable memory device.

Please again refer to FIG. 1, the control unit 13 in the present preferred embodiment can further comprise a switch circuit 131 with pins (not numbered in the figure) connected with the power terminals of the first terminal set 141 and the second terminal set 151 (not numbered in the figure). By applying a voltage (or power) to the power terminal of either the first 141 or the second 151 terminal sets, the switch circuit 131 can switch the control unit 13 to access the data through the terminal set that the voltage is applied to while blocking the other terminal set at the same time (i.e. temporary disabling the I/O interface controller that no power has been applied). Accordingly, the portable memory device 10 can access the data through either the first 14 or the second I/O interface unit at a time. In case of both terminal sets 14, 15 are connected with an external device 20, 30 individually, the I/O interface that is connected first will have the priority in control to avoid error or lost of the data stored in the portable memory device 10. Of course in the other preferred embodiment the switch circuit can be designed to let the I/O interface that is connected later to have the control.

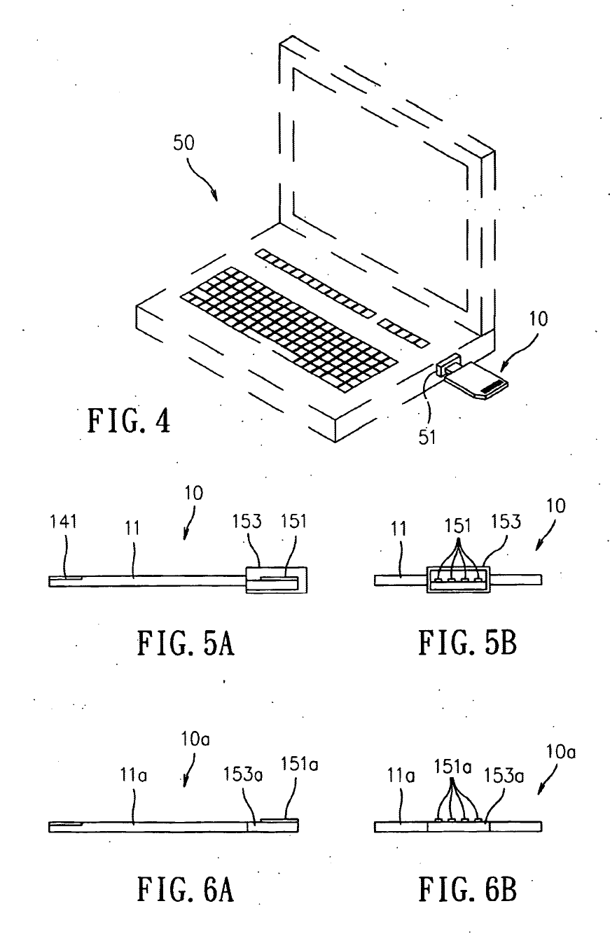

Please refer to FIG. 3 and FIG. 4. Typically, most of the hand held electronic devices, such as digital cameras, cellular phones, digital videos, MP3 players, electronic dictionaries, PDAs, and etc., have the memory card slot 41 in either an SD, a MS, a MMC, a CF, or an xD I/O interface standard and capable of accommodating the portable memory device 10 possessing the same I/O interface standard. On the other hand, a PCMCIA, an USB, a wire LAN, or a wireless LAN I/O interface plug 51 is commonly used in computers 50, such as PCs, notebooks, tablet PCs, or PDAs. In the current market, some of the printers or scanners are equipped with different kinds of memory card interface slots or USB I/O interface plugs. Conventionally, the portable memory device uses either a minimized SD, MS, MMC, CF, or xD memory card interface, or a PCMCIA or USB I/O interface for the computer. As the consequence, a portable memory device that uses USB interface (such as an USB flash disk) can not be used in a digital camera or other external devices, while a portable memory device with an SD memory card interface or other standards requires a card reader to connect with a computer. The present invention installs two interface units 14, 15 with different standards simultaneously on a single portable memory device, wherein the previous preferred embodiment has an interface unit with one of the memory card interfaces, while the other interface unit is one of the computer I/O interfaces. Therefore, the portable memory device of the present invention is more convenient to use and therefore avoids the needs in purchasing different storage devices with different interfaces and card readers to minimize the cost and the waste in social resources.

The same name and number will be used for the identical elements shown in another preferred embodiment of the present invention hereinafter, while the same name but the same number with an additional English alphabet will be used for the similar elements. Detailed descriptions in the compositions and functions of these elements will be omitted.

Please refer to FIG. 5A and FIG. 5B, which are the front-view and side-view of a portable memory device with multiple I/O interfaces 10 according to FIG. 1. In the present embodiment, the outline of the body 11 of the portable memory device 10 matches the standard of an SD memory card. The first terminal set 141 is arranged at the left-hand side of the body 11 (i.e. the left-hand side of FIG. 5A) and an USB plug 153 is arranged at the right-hand side of the body (i.e. the right-hand side of FIG. 5A) for the second terminal set 151. Since the USB plug 153 is thicker compared with an SD memory card, the USB plug 153 will be exposed (as shown in FIG. 3) when the first terminal set 141 of the portable memory device 10 is inserted into an SD memory card slot 41 (or an SD card reader).

Please refer to FIG. 6A and FIG. 6B, which are a front-view and side-view of a portable memory device 10a with multiple I/O interfaces according to another preferred embodiment of the present invention. In the present embodiment, most of the elements and structures are the same or similar to the one described in FIG. 1, FIG. 5A, and FIG. 5B that further descriptions are omitted. The difference between the embodiment shown in FIG. 6A and FIG. 6B and the embodiment shown in FIG. 5A and FIG. 5B is that in FIG. 6A and FIG. 6B, the thickness of the USB interface plug 153a of the portable memory device 10a is close to the thickness of the body 11a. In another word, the present preferred embodiment removes the outer shell of a standard USB plug and keeps only the structure of the second terminal set 151a in the USB plug 153a (i.e. the second terminal set 151a and its plastic supporting). As the result, the thickness of the USB plug 153a is similar or even smaller than the thickness of the. body 11a. Therefore, when connecting to an external device with the SD interface, such as an SD memory card slot (or card reader) that is longer in depth, the USB plug 153a of the portable memory device 10a of the present embodiment will not be exposed.

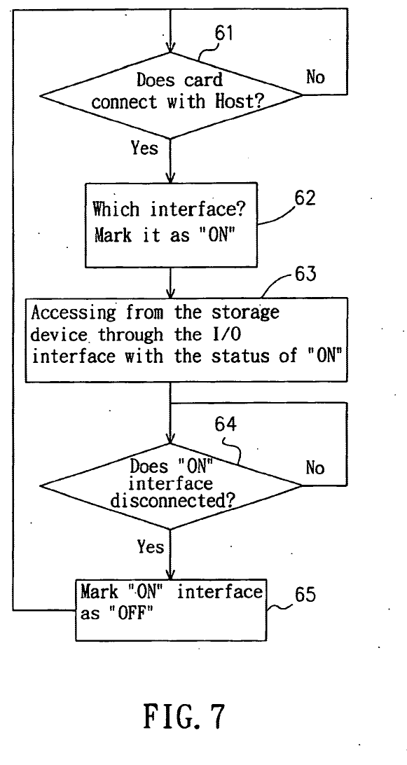

Please refer to FIG. 7, which is a functional flow chart of a portable memory device with multiple I/O interfaces connected with an external device according to the present invention. The procedure includes the following steps:
Step 61: Checking if there is a connection. The controller circuit of the portable memory device determines if there is a connection with external devices. Typically, this can be done by detecting the changes in the voltage of the power terminal or by the hand shaking signal from the signal terminal. If the result is “no”, then remain idle; if the result is “yes”, then proceed to Step 62.
Step 62: Checking the interface of the connection and marking the status of the connected interface as “ON”. The controller circuit of the portable memory device determines the I/O interface that is connected with an external device and marks the status of the connected interface as “ON”.
Step 63: Accessing data stored in the storage device through the I/O interface with the status of “ON”. Controlling the external device and accessing the data from the storage device of the portable memory device by the I/O interface controller with the status of “ON”.
Step 64: Checking if the I/O interface with the status of “ON” is disconnected. Determine if the I/O interface with the status of “ON” and the external device are disconnected. If “no”, remain Step 63; if“yes”, then proceed to Step 65.
Step 65: Changing the status of the I/O interface from “ON” to “OFF”.

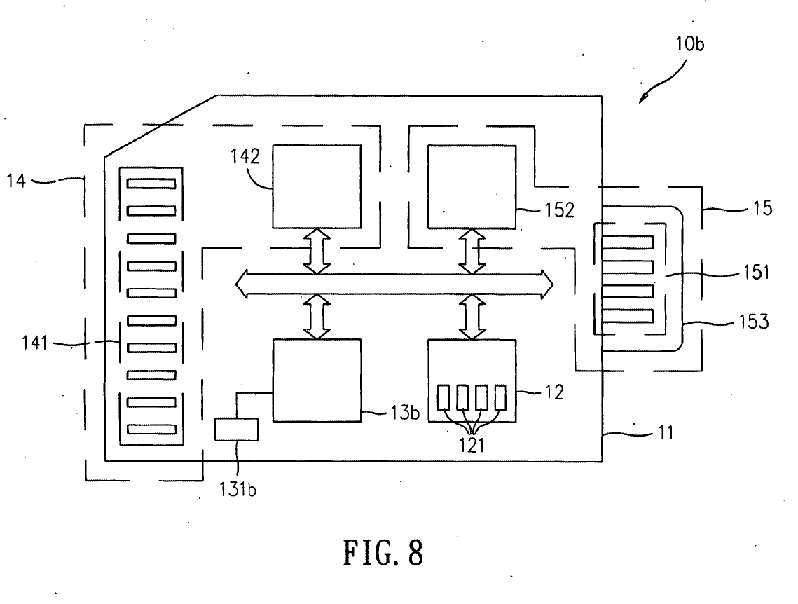

Please refer to FIG. 8, which is a schematic drawing of a portable memory device with multiple I/O interfaces 10b according to a second preferred embodiment of the present invention. Since most of the elements of the present embodiment in FIG. 8 are the same as those in the embodiment shown in FIG. 1, further descriptions are omitted. The only difference is that, in the present preferred embodiment shown in FIG. 8, the switch circuit 131b of the portable memory device 10b is not built inside the control unit 13b, but is an independent electrical circuit element coupled with the control unit 13b.

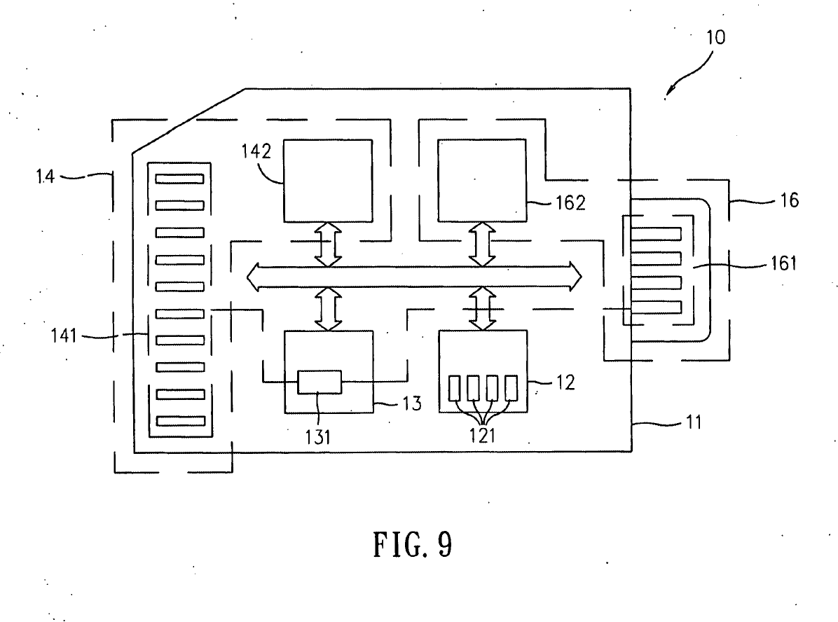

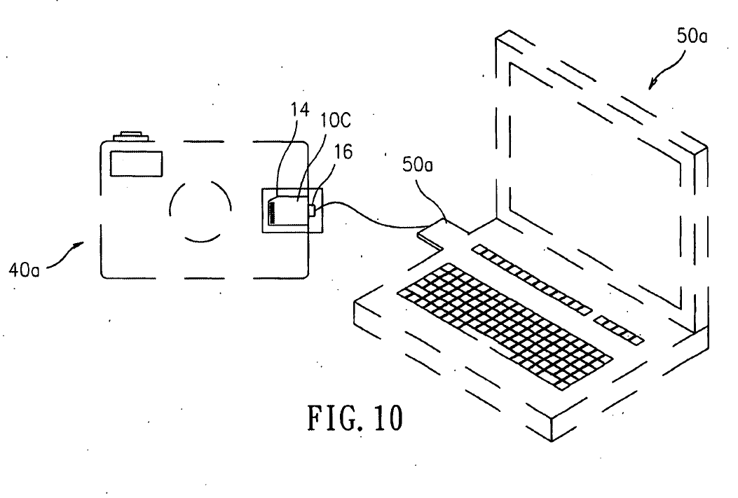

Pleaser refer to FIG. 9, which is a schematic drawing of a portable memory device with multiple I/O interfaces 10c according to a third preferred embodiment of the present invention. Since most of the elements of the present embodiment in FIG. 10 are the same as those in the embodiment shown in FIG. 1, further descriptions are omitted. The only difference is that, in the present preferred embodiment shown in FIG. 10, the second I/O interface unit 16 of the portable memory device 10c is a wire LAN I/O interface with corresponding second terminal set 151 and second I/O interface controller 152. Although the I/O interface of the present preferred embodiment is a wire LAN (i.e. a wire local area network) I/O interface, it can be a wireless LAN (i.e. a wireless local area network) I/O interface as well. The portable memory device 10c is capable of connecting and functioning with a first and a second external device simultaneously (as shown in FIG. 10). Wherein, the first external device in the present preferred embodiment is a digital camera 40a and the second external device is a notebook 50a with a wire LAN I/O interface. The digital camera 40a and the notebook 50a can both read the data in the portable memory device 10c at the same time, but only one of them is allowed to modify and write data to the portable memory device 10c at a time to prevent modifying the same data together or making errors or losing data stored in the portable memory device 10c.

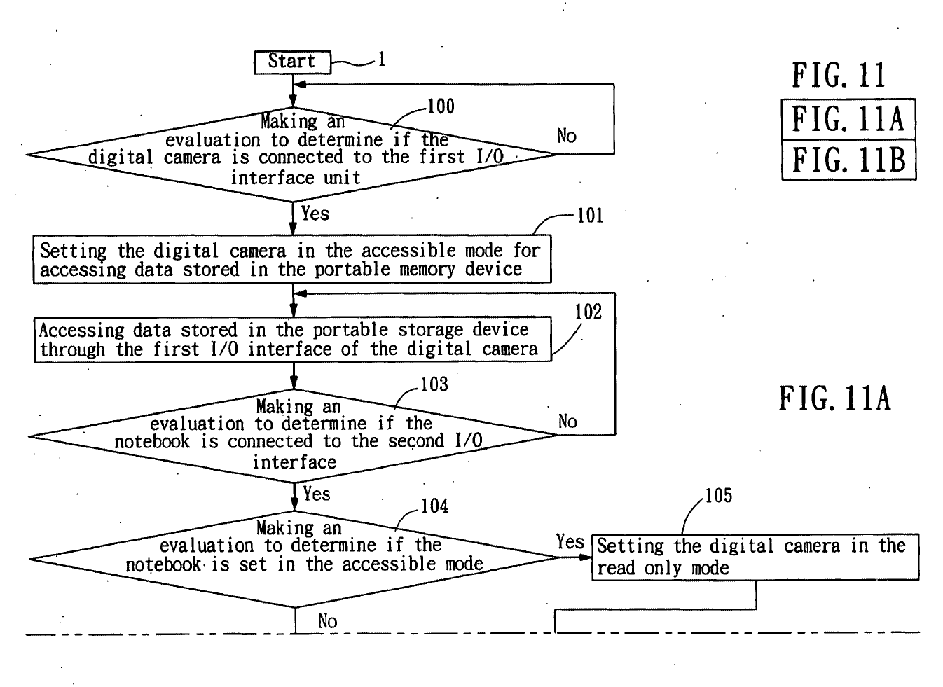

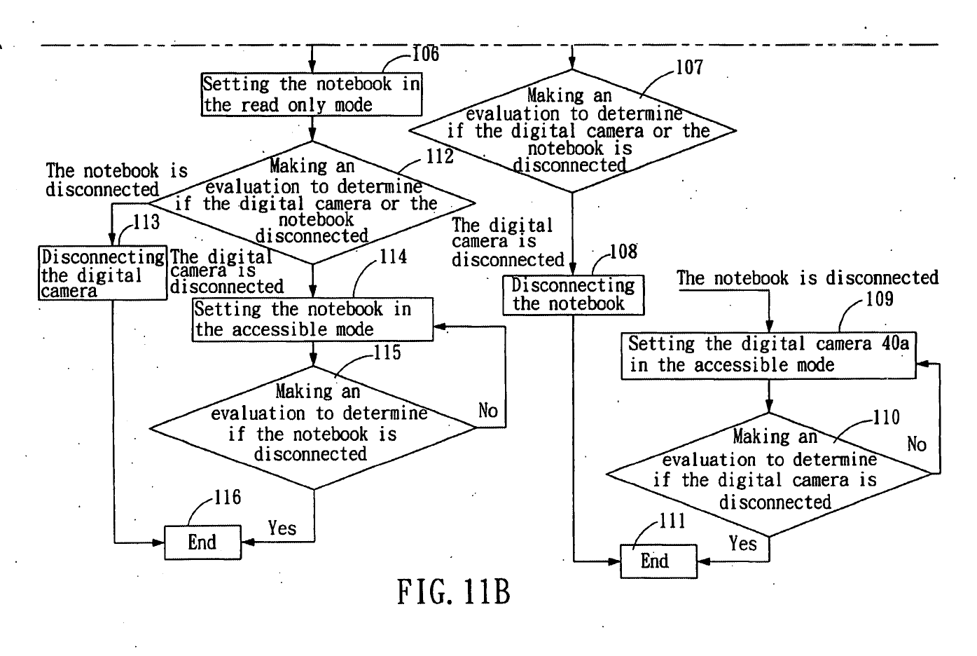

Please refer to FIG. 11, which is a flow chart of the portable memory device 10c functioning with both digital camera 40a and notebook 50a. The procedure includes the following steps:
Step 1: Start;
Step 100: Making an evaluation to determine if the digital camera 40a is connected to the first I/O interface unit 14 (which is an SD memory card in the present preferred embodiment). If “yes”, proceed to Step 101. If “no”, proceed to Step 100;
Step 101: Setting the digital camera 40a in the accessible mode. In this mode, the digital camera 40a can read data from and write data to the portable memory device 10c;
Step 102: Accessing data stored in the portable storage device 10c through the first I/O interface 14 of the digital camera 40a;
Step 103: Making an evaluation to determine if the notebook 50a is connected to the second I/O interface 16 (which is a wire LAN in the present preferred embodiment). If “yes”, proceed to Step 104. If “no”, proceed to Step 102;
Step 104: Making an evaluation to determine if the notebook 50a is set in the accessible mode. If “yes”, proceed to Step 105. If “no”, proceed to Step 106;
Step 105: Setting the digital camera 40a in the read only mode. In this mode, the digital camera 40a can only read the data stored in the portable memory device 10c;
Step 106: Setting the notebook 50a in the read only mode. In this mode, the notebook 50a can only read the data stored in the portable memory device 10c;
Step 107: Making an evaluation to determine if the digital camera 40a or the notebook 50a is disconnected. If the digital camera 40a is disconnected, proceed to Step 108. If the notebook 50a is disconnected, proceed to Step 109;
Step 108: Disconnecting the notebook 50a;
Step 109: Setting the digital camera 40a in the accessible mode. In this mode, the digital camera 40a can both read data from and write data to the portable memory device 10c;
Step 110: Making an evaluation to determine if the digital camera 40a is disconnected. If “yes”, proceed to Step 111. If “no”, proceed to Step 109;
Step 111: End;
Step 112: Making an evaluation to determine if the digital camera 40a or the notebook 50a is disconnected. If the digital camera 40a is disconnected, proceed to Step 114. If the notebook 50a is disconnected, proceed to Step 113;
Step 113: Disconnecting the digital camera 40a;
Step 114: Setting the notebook 50a in the accessible mode. In this mode, the notebook 50a can both read data from and write data to the portable memory device 10c;
Step 115: Making an evaluation to determine if the notebook 50a is disconnected. If “yes”, proceed to Step 116. If “no”, proceed to Step 114;
Step 116: End;

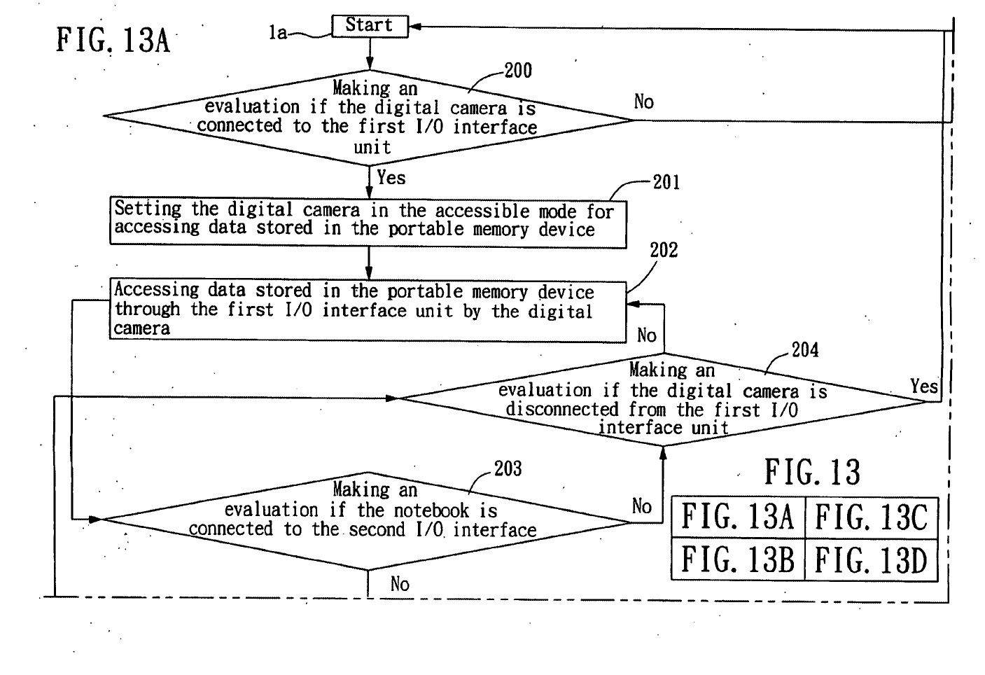

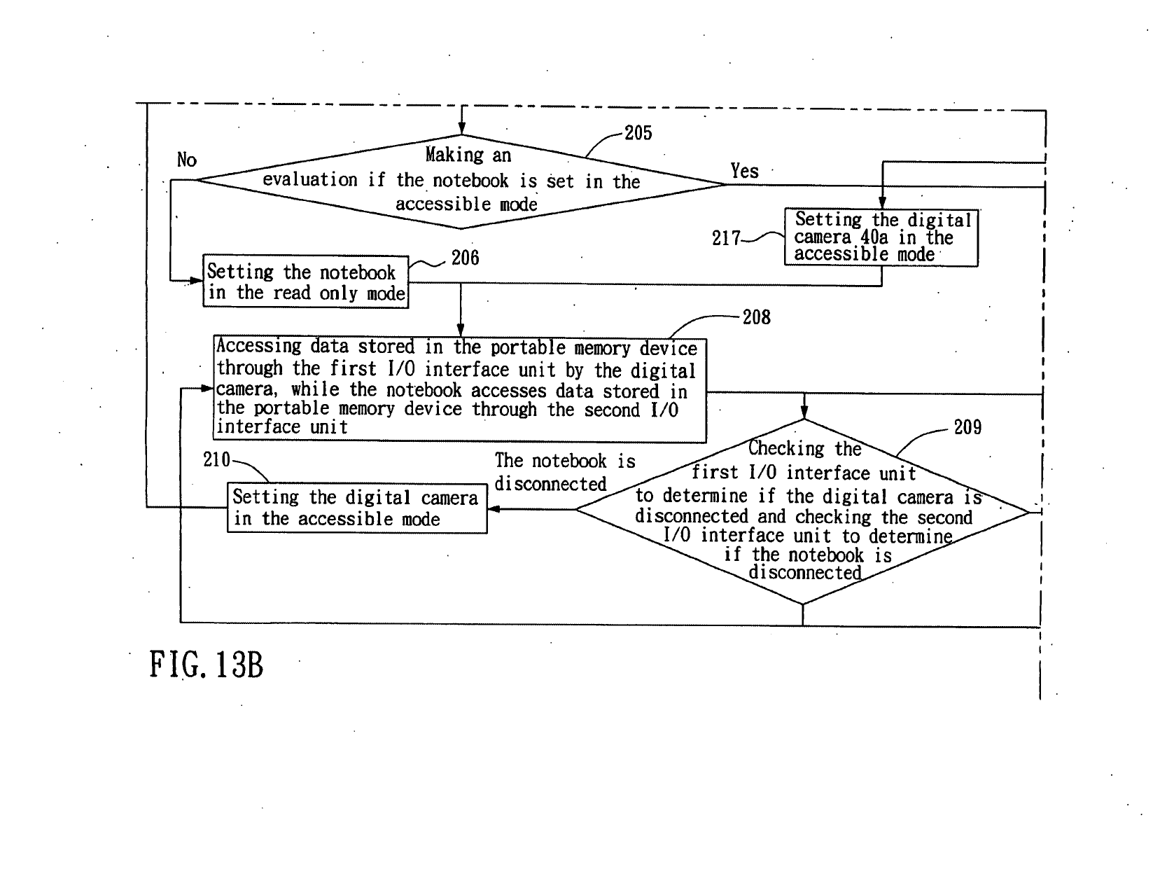

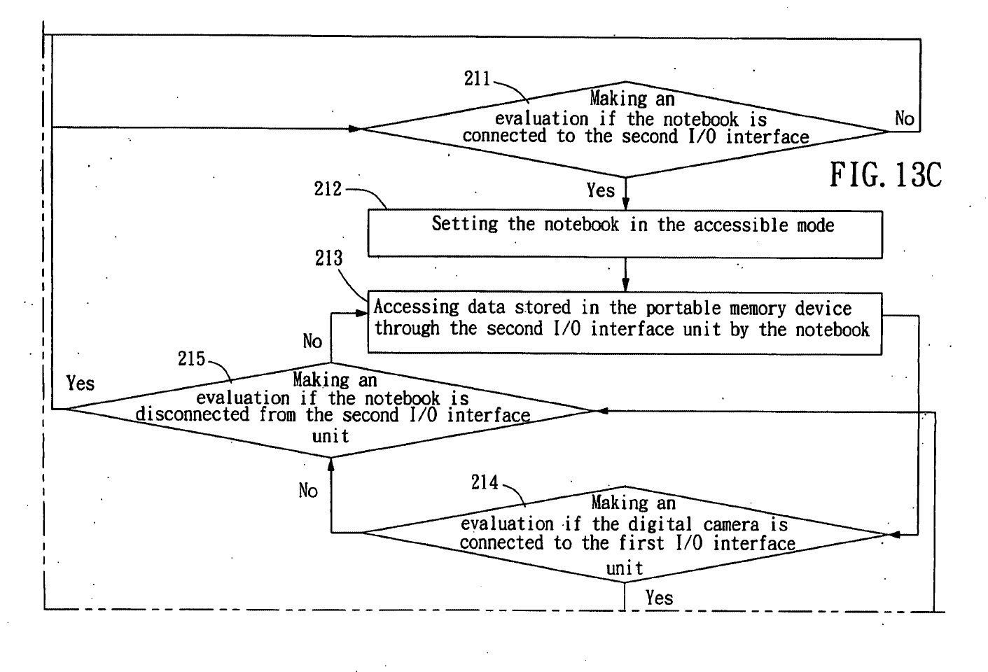

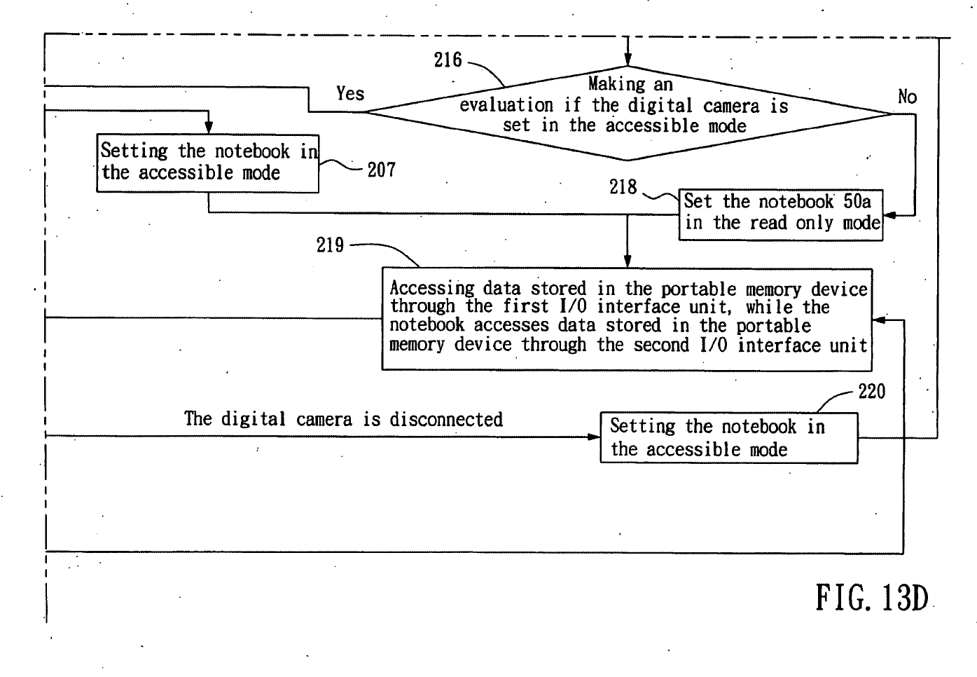

Please refer to FIG. 13, which is another flow chart of the portable memory device 10c functioning with both digital camera 40a and notebook 50a according to FIG. 10. The procedure includes the following steps:
Step 1a: Start;
Step 200: Making an evaluation if the digital camera 40a is connected to the first I/O interface unit 14 (which is an SD memory card in the present preferred embodiment). If “yes”, proceed to Step 201. If “no”, proceed to Step 211;
Step 201: Setting the digital camera 40a in the accessible mode. In this mode, the digital camera 40a can read and write data to the portable memory device 10c;
Step 202: Accessing data stored in the portable memory device 10c through the first I/O interface unit 14 by the digital camera 40a;
Step 203: Making an evaluation if the notebook 50a is connected to the second I/O interface 16 (which is a wire LAN in the present preferred embodiment). If “yes” proceed to Step 205. If“no”, proceed to Step 204;
Step 204: Making an evaluation if the digital camera 40a is disconnected from the first I/O interface unit 14. If “yes”, proceed to Step 1a. If “no”, proceed to Step 202;
Step 205: Making an evaluation if the notebook 50a is set in the accessible mode. If “yes”, proceed to Step 207. If“no”, proceed to Step 206;
Step 206: Setting the notebook 50a in the read only mode. In this mode, the notebook 50a can only read the data stored in the portable memory device 10c;
Step 207: Setting the notebook 50a in the accessible mode. In this mode, the notebook 50a can both read and write data to the portable memory device 10c;
Step 208: Accessing data stored in the portable memory device 10c through the first I/O interface unit 14 by the digital camera 40a, while the notebook 50a accesses data stored in the portable memory device 10c through the second I/O interface unit 16;
Step 209: Checking the first I/O interface unit 14 to determine if the digital camera 40a is disconnected and checking the second I/O interface unit 16 to determine if the notebook 50a is disconnected. If the digital camera 40a is disconnected, proceed to Step 220. If the notebook 50a is disconnected, proceed to Step 210;
Step 210: Setting the digital camera 40a in the accessible mode. In this mode, the digital camera 40a can both read and write data to the portable memory device 10c;
Step 211: Making an evaluation if the notebook 50a is connected to the second I/O interface 16. If “yes”, proceed to Step 212. If “no”, proceed to Step 1a;
Step 212: Setting the notebook 50a in the accessible mode. In this mode, the notebook 50a can both read and write data to the portable memory device 10c;
Step 213: Accessing data stored in the portable memory device through the second I/O interface unit 16 by the notebook 50a;
Step 214: Making an evaluation if the digital camera 40a is connected to the first I/O interface unit 14. If “yes”, proceed to Step 216. If “no”, proceed to Step 215;
Step 215: Making an evaluation if the notebook 50a is disconnected from the second I/O interface unit 16. If “yes”, proceed to Step 1a. If “no”, proceed to Step 213;
Step 216: Making an evaluation if the digital camera 40a is set in the accessible mode. If “yes”, proceed to Step 217. If “no”, proceed to Step 218;
Step 217: Setting the digital camera 40a in the accessible mode;
Step 218: Set the notebook 50a in the read only mode;
Step 219: Accessing data stored in the portable memory device 10c through the first I/O interface unit 14, while the notebook 50a accesses data stored in the portable memory device 10c through the second I/O interface unit 16;
Step 220: Setting the notebook 50a in the accessible mode;

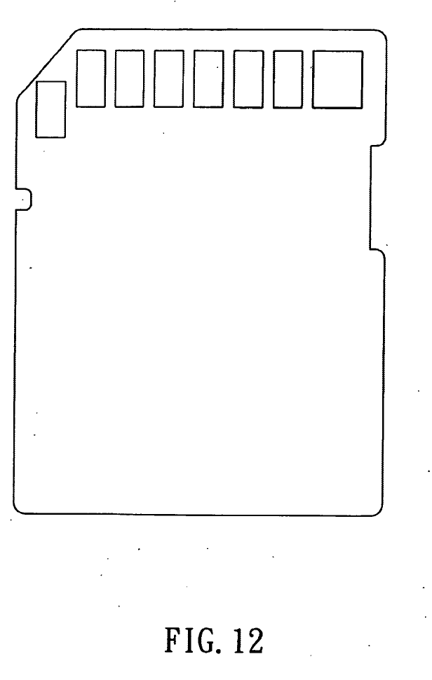

Please refer to FIG. 12, which is a schematic drawing of an SD flash memory card. It is noted that although the above-mentioned portable memory device of the present invention uses an SD flash memory card with the outline shown in FIG. 9 in describing the preferred embodiments of the present invention, these preferred embodiments are however not the limited scope of the present invention. Any appropriate and small variation and adjustment based on the appended claims that still possess the merit of the present invention should be considered within the scope and the spirit of the present invention.

1. A portable memory device with multiple I/O interfaces, comprising:
a body;
a storage device, installed on said body;
a control unit, installed on said body and connected with said storage device, capable of driving and controlling said storage device to access data;
a first terminal set, arranged at one side of said body, being distributed according to the standard of a first I/O interface;
a second terminal set, arranged at the opposite side of said first terminal set on the body, being distributed according to the standard of a second I/O interface;
a first I/O interface controller, connected with said first terminal set and said control unit, capable of converting the data signal from said first terminal set with the standard of said first I/O interface to the data that can be stored in the storage device, and converting the data from said storage device to the data signal with the standard of said first I/O interface and then sending out by said first terminal set; and
a second I/O interface controller, connected with said second terminal set and said control unit, capable of converting the data signal from said second terminal set with the standard of said second I/O interface to the data that can be stored in the storage device, and converting the data from said storage device to the data signal with the standard of said second I/O interface and then sending out by said second terminal set.

2. The portable memory device with multiple I/O interfaces according to claim 1, wherein said control unit is capable of controlling said storage device to perform a write operation through only one object selected from the group consisting of said first terminal set and said second terminal set at a time.

3. The portable memory device with multiple I/O interfaces according to claim 1, wherein said control unit is capable of controlling said storage device to perform a read operation through both said first terminal set and said second terminal set at a time.

4. The portable memory device with multiple I/O interfaces according to claim 1, wherein said portable memory device is a memory card.

5. The portable memory device with multiple I/O interfaces according to claim 1, wherein said body has a card structure.

6. The portable memory device with multiple I/O interfaces according to claim 1, wherein said storage device is one selected from the group consisting of a flash memory array, a random access memory (RAM), a read only memory (ROM), an erasable programmable ROM (EPROM), and an electrical erasable programmable ROM (EEPROM).

7. The portable memory device with multiple I/O interfaces according to claim 1, wherein the specifications of said first I/O interface and said second I/O interface are different and incompatible.

8. The portable memory device with multiple I/O interfaces according to claim 1, wherein said first I/O interface is one selected from the group consisting of a PCMCIA, an USB, an SD, a MS, a MMC, a CF, an xD, a wire LAN, and a wireless LAN.

9. The portable memory device with multiple I/O interfaces according to claim 1, wherein said second I/O interface is one selected from the group consisting of a PCMCIA, an USB, an SD, a MS, a MMC, a CF, an xD, a wire LAN, and a wireless LAN.

10. The portable memory device with multiple I/O interfaces according to claim 1, further comprising a switch circuit with pins connected with the power terminals of said first terminal set and said second terminal set, wherein by selectively applying a voltage on said power terminal connected to said first terminal set for enabling switch circuit to direct said control unit to access data through said first terminal, and by selectively applying a voltage on said power terminal connected to said second terminal set for enabling switch circuit to direct said control unit to access data through said second terminal.

11. The portable memory device with multiple I/O interfaces according to claim 1, wherein said second terminal set is an USB plug.

12. The portable memory device with multiple I/O interfaces according to claim 11, wherein the thickness of said second terminal set is close to the thickness of said body.

13. A portable memory device with multiple I/O interfaces, comprising:
a portable memory device, said portable memory device further comprising:
a body;
a storage device, installed on said body;
a control unit, installed on said body and connected with said storage device capable of driving and controlling said storage device to access data;
a first I/O interface unit, connected with said control unit, capable of transferring the data stored in said storage device through said first I/O interface unit with the standard of said first I/O interface; and
a second I/O interface unit, connected with said control unit capable of transferring the data stored in said storage device through said second I/O interface unit with the standard of said second I/O interface.
a first external device, capable of accessing the data through at least the standard of said first I/O interface, wherein said first external device can connect with said first I/O interface unit electronically and access the data stored in said storage device; and
a second external device, capable of accessing the data through at least the standard of said second I/O interface, wherein said second external device can connect with said second I/O interface unit electronically and access the data stored in said storage device.

14. The portable memory device with multiple I/O interfaces according to claim 13, wherein said control unit is capable of controlling said storage device to perform a write operation through only one object selected from the group consisting of said first external device and said second external device at a time.

15. The portable memory device with multiple I/O interfaces according to claim 13, wherein said control unit is capable of controlling said storage device to perform a read operation on both said first external device and said second external device at a time.

16. The portable memory device with multiple I/O interfaces according to claim 13, wherein said portable memory device is a memory card.

17. The portable memory device with multiple I/O interfaces according to claim 13, wherein said storage device is selected from the group consisting of a flash memory array, a random access memory (RAM), a read only memory (ROM), an erasable programmable ROM (EPROM), and an electrical erasable programmable ROM (EEPROM).

18. The portable memory device with multiple I/O interfaces according to claim 13, wherein the specifications of said first I/O interface and said second I/O interface are different and incompatible.

19. The portable memory device with multiple I/O interfaces according to claim 13, wherein said first I/O interface and said second I/O interface are selected from the group consisting of a PCMCIA, an USB, an SD, a MS, a MMC, a CF, an xD, a wire LAN, and a wireless LAN.

20. The portable memory device with multiple I/O interfaces according to claim 13, further comprising a switch circuit with pins connected with the power terminals of said first terminal set and said second terminal set, wherein by selectively applying a voltage on said power terminal connected to said first terminal set for enabling switch circuit to direct said control unit to access data through said first terminal, and by selectively applying a voltage on said power terminal connected to said second terminal set for enabling switch circuit to direct said control unit to access data through said second terminal.

21. The portable memory device with multiple I/O interfaces according to claim 13, wherein said first external device and said second external device respectively is one object selected from the group consisting of a digital camera, a PDA, a PC, a notebook, a printer, a scanner, a digital video, a tablet PC, a network card, a wireless network card, and a card reader.
